(19) United States
(12) Patent Application Publication
(10) Pub. No.: US 2003/0217131 A1
(43) Pub. Date: Nov. 20, 2003

(54) Processing distribution using instant copy

(75) Inventors: Leslie K. Hodge, Westminster, CO (US); Scott E. Ledbetter, Golden, CO (US)

Correspondence Address: Wayne P. Bailey, Storage Technology Corporation, One StorageTek Drive, Louisville, CO, 80028-4309, US

(73) Assignee: Storage Technology Corporation

(21) Appl. No.: 10/147,831

(22) Filed: May 17, 2002

(51) Int. Cl. G06F 15/173

(52) U.S. Cl. 709/223

(57) ABSTRACT

The present invention provides a software-based solution for deploying virtual servers in a computer network. The method is initiated when an end user requesting a new virtual server clicks a hyperlink in which an imbedded command sequence requests the software to deploy a new virtual server. The software automatically updates the hypervisor environment to include the new virtual server, prepares the new virtual server disk allocations, propagates a server model image into the new virtual server, updates the new image with local identification parameters, and then boots the new virtual server.

### BACKGROUND OF THE INVENTION

1. Field of the Invention

The present invention relates generally to computer networks, and more specifically to the creation of virtual servers within a network.

2. Background of the Invention

As traffic on computer networks increases, the load placed on servers often causes the servers to become overloaded for periods of time, especially for popular web services. One solution to the increased server loads is to upgrade the individual servers. However, the upgrading process is complex and expensive, and eventually the server will have to be upgraded again.

Another solution is the multi-server approach. This involves building a scalable server (virtual server) on a cluster of servers. When load increases, new servers can be added to the cluster to handle the increased requests. Though a virtual server comprises multiple physical servers, it appears as a single server or system image to outside networks and end users.

The process of creating virtual servers on a computer network involves the manual execution of unrelated tasks, including virtual machine definition, specifying network parameter definitions, disk media preparation, operating system kernel creation from installation media, and virtual server initiation. These tasks require the manual input of various prompt responses, as well as non-responsive inputs in which incorrect input can yield unsuccessful server deployment. This input requires technical user knowledge and several hour of time to complete, sometimes up to six hours. This process may also require the ad hoc availability of technical personnel to provide limited support to define the virtual machine (hosting the virtual server) and provide network definition information to the server installer.

Therefore, it would be desirable to have a method for automating the creation of virtual servers, thus reducing the time, cost and complexity of the process.

### SUMMARY OF THE INVENTION

The present invention provides a software-based solution for deploying virtual servers in a computer network. The method is initiated when an end user requesting a new virtual server clicks a hyperlink in which an imbedded command sequence requests the software to deploy a new virtual server. The software automatically updates the hypervisor environment to include the new virtual server, prepares the new virtual server disk allocations, propagates a server model image into the new virtual server, updates the new image with local identification parameters, and then boots the new virtual server.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a schematic diagram illustrating virtual servers deployed on a mainframe in accordance with the present invention;

FIG. 3 depicts a flowchart illustrating the manual process of creating a virtual server in accordance with the prior art;

FIG. 4 depicts a flowchart illustrating the process of deploying a virtual server by means of an automated software solution in accordance with the present invention; and

FIG. 5 depicts a schematic diagram illustrating the architecture of the virtual machine environment of the automated software solution in accordance with the present invention.

### DETAILED DESCRIPTION OF THE PREFERRED EMBODIMENT

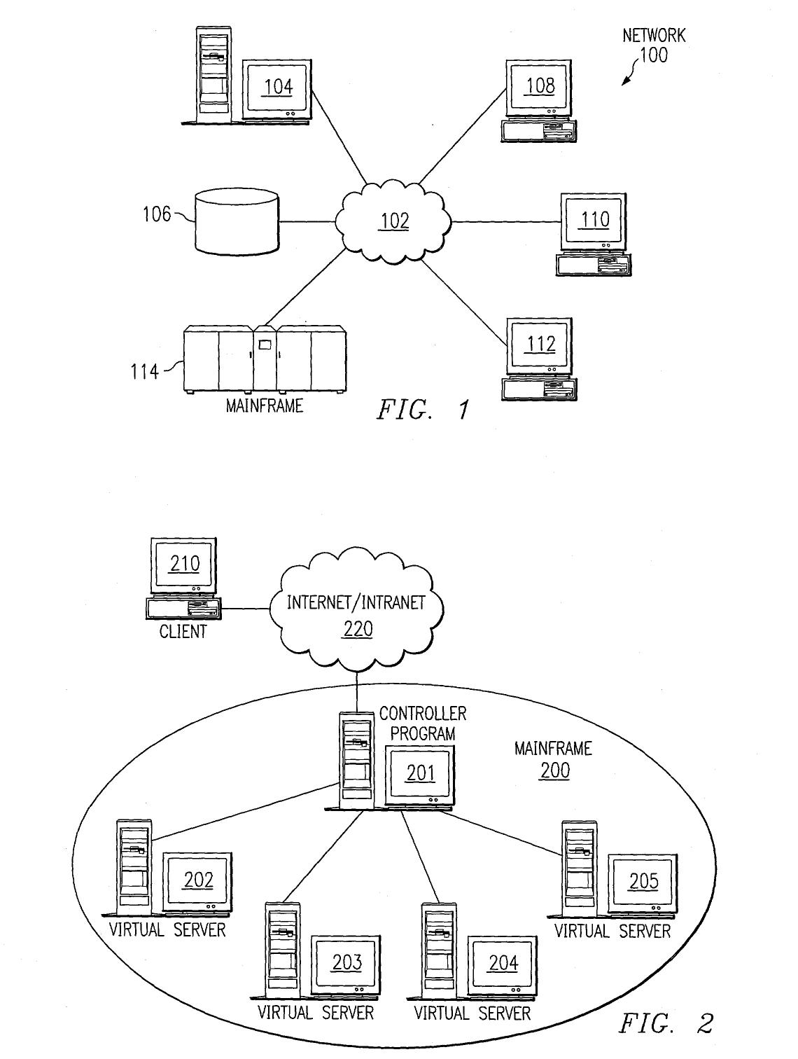

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with mainframe 114 and storage unit 106. In addition, clients 108, 110, and 112 also are connected to network 102. These clients 108, 110, and 112 may be, for example, personal computers or network computers. In the depicted example, server 104 and mainframe 114 may provide data, such as boot files, operating system images, and applications to clients 108-112. In addition, mainframe 114 may host one or several virtual servers. Clients 108, 110, and 112 are clients to server 104 and mainframe 114. Network data processing system 100 may also include additional servers, clients, and other devices not shown (e.g., printers).

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring now to FIG. 2, a schematic diagram illustrating virtual servers deployed on a mainframe is depicted in accordance with the present invention. The virtual server 200 hosts multiple virtual servers 202-205, which contain identical applications. Though each virtual server 202-205 has its own IP address, the architecture of the virtual server cluster is transparent to the client 210, which sees only a single server. The front-end Control Program 201 acts as the load balancer, which schedules service requests among the virtual servers 202-205 in the cluster. The granularity of scheduling requests is per connection.

The Control Program 201 is a component of the Virtual Machine (VM) hypervisor that is responsible for dispatch and control functions. The Control Program 201 will dispatch virtual machines from an “eligible to run” list based upon various parameters (e.g., priority, I/O status, memory overhead support, etc.). Control Program 201 also controls and virtualizes the TCP/IP processing for TCP/IP requests coming from outside the mainframe 200 (i.e. from network 220).

As it relates to the virtual servers 202-205, the primary purposes of the Control Program 201 are to (1) dispatch virtual machines (servers) for a given timeslice and (2) dispatch I/O to and from storage, network 220, and display devices. The Control Program 201 does not actually control the activity that occurs inside a virtual server environment. Instead, the Control Program 201 manages the resources used by the virtual servers for their own independent processing. In addition, the Control Program 201 may also be a server itself.

Scalability for virtual server cluster is achieved by transparently adding or removing nodes from the cluster of virtual servers (described below). Failover is provided by detecting node failures and reconfiguring the system appropriately.

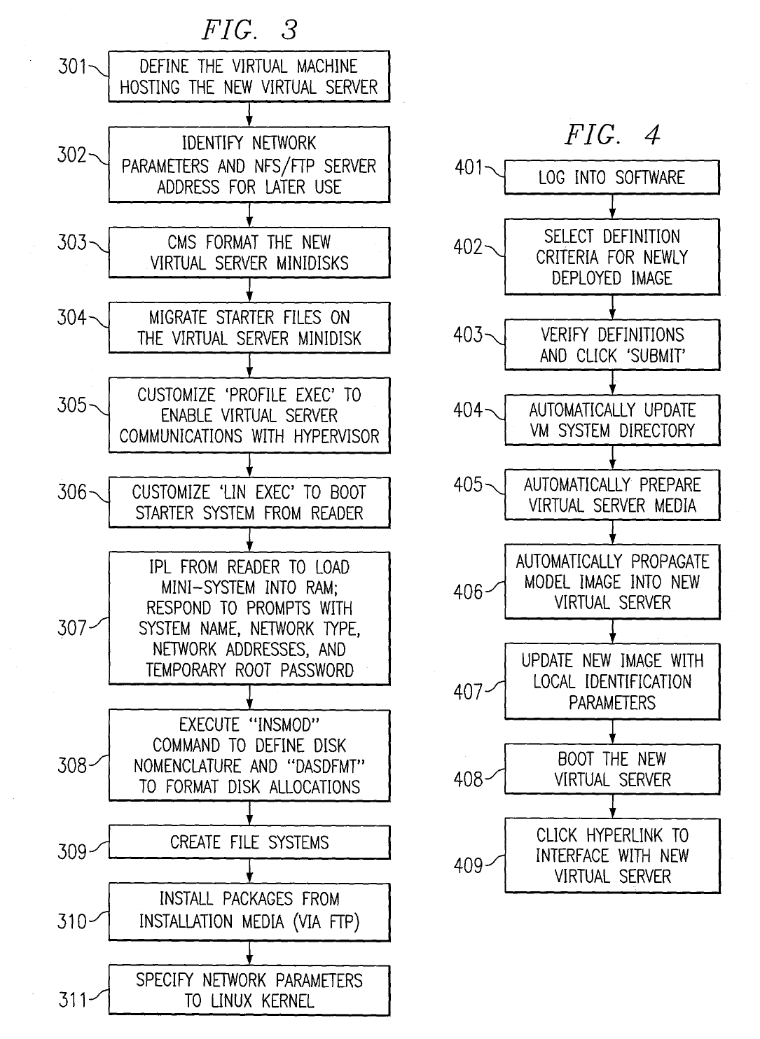

Referring to FIG. 3, a flowchart illustrating the manual process of creating a virtual server is depicted in accordance with the prior art. This process requires keyed input responses to various installation prompts and often requires the ad hoc availability of several technical personnel to provide support. The following example uses Virtual Machine (VM) and Linux system concepts, but it must be kept in mind that virtual servers may be implemented using other formats.

The first step in manually creating a virtual server is for the VM system programmer to define the virtual machine hosting the new virtual server (step 301). This is done in the VM system directory. Next, the network administrator and Linux server installer identify the network parameters and network file system/file transfer protocol (NFS/FTP) server address for later user (step 302).

The Linux server installer formats the new virtual server minidisks in Conversational Monitor System (CMS) Format (step 303), and then migrates the starter files on the virtual server minidisk (step 304). The server installer customizes the ‘profile exec’ file to enable virtual server communications with the hypervisor (step 305), and customizes the ‘lin exec’ file to boot the starter system from the reader (step 306).

The server installer then performs the Initial Program Load (IPL) from the reader to load the mini-system into RAM; responds to prompts with the system name, network type, network addresses, and temporary root password (step 307). The “insmod” and “dasdfmt” commands are executed to define disk nomenclature and format the disk allocations, respectively (step 308).

File systems are created (step 309), and the packages are installed from FTP installation media (step 310). Finally, the server installer specifies the network parameters to the Linux kernel (step 311).

All together, steps 301-311 take about six hours to complete. Furthermore, an incorrect response to an installation prompt can terminate the installation process, requiring the installer to reinitiate the installation process from the beginning.

The present invention provides a software-based solution that automates the deployment of virtual servers into a rapid, end user-initiated process. The present example is described within the context of the SnapVantage software solution, but it should be pointed out that the features of the present invention may be implemented by means of other software solutions.

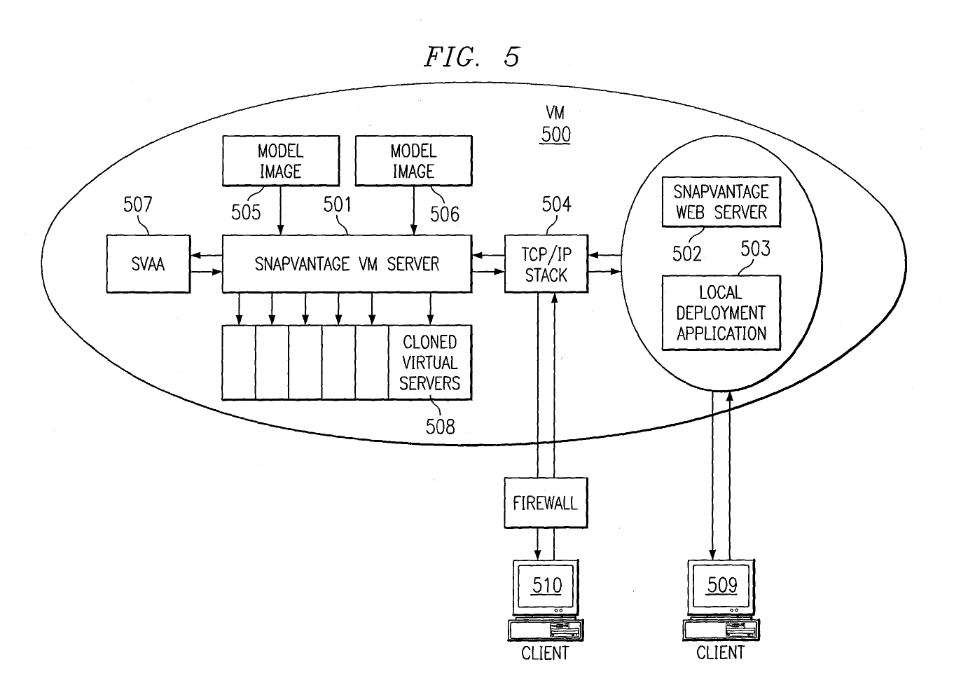

Referring to FIG. 4, a flowchart illustrating the process of deploying a virtual server by means of an automated software solution is depicted in accordance with the present invention. The process begins when the user logs into the software (step 401) and selects definition criteria for the newly deployed system image (step 402). The definition criteria include the following: a pool of TCP/IP addresses that the software assigns to newly deployed virtual servers, a pool of names the software assigns to the new virtual servers, and a model image that is used as a target image for the creation and deployment of the new virtual server.

Each virtual server deployed by the software is based upon a model image, e.g., Model Linux Image (MLI). A model image is the current contents of memory, including the operating system and running programs. More than one model image can be defined, each designed to boot for a specified purpose (e.g., web server image, file/print server image, etc). Every new virtual server is an exact copy of the appropriate model image (e.g., web server image), except for the dynamic network and server definitions that identify each server as a unique entity.

Using the Linux example, an MLI is defined to SnapVantage after that image has been created using the existing Linux virtual server definition process. Once created, the MLI is updated with the addition of a deployment script that will be propagated along with the rest of the MLI. This deployment script is then executed in a new virtual server to facilitate the unique identification of the new virtual server.

The user verifies the definition criteria and clicks a “submit” link to submit the criteria (step 403). This link contains an imbedded command sequence that requests SnapVantage to rapidly deploy a new virtual server.

In response to the request from the user, SnapVantage automatically updates the VM system directory to include the new virtual server (step 404). The process to dynamically update the VM system directory starts with the software generating an input stream to a directory management facility (e.g., VM: Secure, DIRMAINT). This input stream contains the definitions for the soon-to-be-deployed virtual server that will be applied to the new directory entry, based upon a template and environmental definitions made to the software. Once the directory management software accepts the input stream, the VM directory is updated with the new virtual machine.

SnapVantage then prepares the virtual server media by using Instant Format (a prerequisite for Linux file system addressibility) to prepare the disk allocation for the newly created virtual server (step 405).

SnapVantage uses the SnapShot Instant Copy Function to propagate the selected server model image into the new virtual server (step 406). At the conclusion of the propagation, the new image is identical to the model image, except it resides in another disk allocation assigned to the new virtual server.

To make the newly deployed image a unique server entity the new image is updated with local identification parameters (step 407). This is accomplished by executing the imbedded SnapVantage scripts that are part of the model image to establish a socket connection with the SnapVantage VM server (described below). Within this connection, the local definition parameters for this newly deployed server are transmitted from the SnapVantage VM server and used by the scripts as inputs for the dynamic updating of the local Linux configuration files that establish the unique identity for this new virtual server.

Once the local Linux configuration files are updated, the final step of the deployment process is to boot the new Linux image using the newly updated configuration information (step 408).

After the new virtual server is deployed, the end user simply clicks another link in order to interface with the new server (step 409).

The entire process of deploying a new virtual server by means of the present invention takes less than five minutes. In addition, the user needs little or no technical knowledge to use the present invention.

Referring now to FIG. 5, a schematic diagram illustrating the architecture of the virtual machine environment of the automated software solution is depicted in accordance with the present invention. SnapVantage provides an administrator facility on client 509 (i.e. web GUI or command line interface) to clone, manage, and deploy Linux system images running under the Virtual Machine (VM) operating system. The SnapVantage architecture 500 has three primary components: the VM server 501, the SnapVantage web server 502, and the local deployment application 503.

The SnapVantage VM server 501 is a VM virtual service machine that manages the cloning process of Linux images, i.e. Model Images 505 and 506. This cloning process uses a Shared Virtual Array Administrator (SVAA) 507 in order to create array of cloned virtual servers 508. The function of the SVAA facility is to host the SnapShot Instant Copy and Instant Format functions. There is no direct SVAA function called in the cloning process. SnapShot is the instant copy function that is used to replicate the MLI to the targeted deployment environment. Instant Format is the instant format function used to prepare the disk allocation for use by the virtual server.

SnapVantage runs disconnected and communicates to clients 509 and 510 via TCP/IP 504.

The SnapVantage web server 502 is the location of the web pages used by the SnapVantage GUI on client 509, and executes under a local Apache (or other) web server.

The local deployment application 503 is the user-created code imbedded in local web pages that drives specific SnapVantage functions. This component is deployed in environments that choose to allow end users to define a new virtual server.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, CD-ROMs, and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for deploying a virtual server, the method comprising the computer-implemented steps of:
receiving a request for deployment of the virtual server;
automatically allocating storage media for the virtual server;
automatically copying a predefined model system image into the virtual server; and
automatically booting the virtual server.

2. The method according to claim 1, wherein the request for deploying the virtual server further comprises definition criteria including:
a pool of possible TCP/IP addresses for the virtual server;
a pool of possible names for the virtual server; and
the model system image that is used for the creation and deployment of the virtual server.

3. The method according to claim 1, further comprising automatically updating a virtual machine system directory to include the virtual server.

4. The method according to claim 1, further comprising automatically updating the image of the virtual server with local identification parameters.

5. The method according to claim 1, wherein the model system image contains a deployment script that is executed in the virtual server to facilitate unique identification of the virtual server.

6. The method according to claim 1, wherein the step of allocating storage media for use by the virtual server is performed by an instant format function.

7. The method according to claim 1, wherein the step of copying the model system image to the virtual server is performed by an instant copy function.

8. The method according to claim 1, wherein the virtual server runs on a mainframe computer.

9. The method according to claim 8, wherein the mainframe uses Virtual Machine operating system.

10. A computer program product in a computer readable medium for use in a data processing system, for deploying a virtual server, the computer program product comprising:
instructions for receiving a request for deployment of the virtual server;
instructions for automatically allocating storage media for the virtual server;
instructions for automatically copying a predefined model system image into the virtual server; and
instructions for automatically booting the virtual server.

11. The computer program product according to claim 10, wherein the request for deploying the virtual server further comprises definition criteria including:
a pool of possible TCP/IP addresses for the virtual server;
a pool of possible names for the virtual server; and
the model system image that is used for the creation and deployment of the virtual server.

12. The computer program product according to claim 10, further comprising instructions for automatically updating a virtual machine system directory to include the virtual server.

13. The computer program product according to claim 10, further comprising instructions for automatically updating the image of the virtual server with local identification parameters.

14. The computer program product according to claim 10, wherein the model system image contains a deployment script that is executed in the virtual server to facilitate unique identification of the virtual server.

15. The computer program product according to claim 10, wherein the step of allocating storage media for use by the virtual server is performed by an instant format function.

16. The computer program product according to claim 10, wherein the step of copying the model system image to the virtual server is performed by an instant copy function.

17. The computer program product according to claim 10, wherein the virtual server runs under a Virtual Machine operating system.

18. A system for deploying a virtual server, the system comprising:
a means for receiving a request for deployment of the virtual server;
a means for automatically allocating storage media for the virtual server;
a means for automatically copying a predefined model system image into the virtual server; and
a means for automatically booting the virtual server.

19. The system according to claim 18, further comprising a means for automatically updating a virtual machine system directory to include the virtual server.

20. The system according to claim 18, further comprising a means for automatically updating the image of the virtual server with local identification parameters.

21. The system according to claim 18, wherein the means for allocating storage media for use by the virtual server further comprises an instant format function.

22. The system according to claim 18, wherein the means for copying the model system image to the virtual server further comprises an instant copy function.

23. The system according to claim 18, wherein the virtual server runs on a mainframe computer.
